(19) United States
(12) Patent Application Publication
(10) Pub. No.: US 2008/0138164 A1
(43) Pub. Date: Jun. 12, 2008

(54) DRILLING PIN FOR MACHINING METAL SUBSTRATES

(76) Inventors: Ching-Ching CHEN, Wugu Township (TW); Ta-Chi Huang, Taipei City (TW)

Correspondence Address: HDSL, 4331 STEVENS BATTLE LANE, FAIRFAX, VA, 22033, US

(21) Appl. No.: 12/032,875

(22) Filed: Feb. 18, 2008

Related U.S. Application Data
(63) Continuation of application No. 10/904,486, filed on Nov. 12, 2004, now Pat. No. 7,344,267.

(51) Int. Cl. B23B 27/20

(52) U.S. Cl. 408/145

(57) ABSTRACT

A drilling pin for machining metal substrates includes a drillstock, a drill bit, and a coating. The drill bit extends from an end of the drillstock, and includes at least two corresponding helix guide grooves. Two knife-edges are formed/defined between the at least two helix guide grooves. A helix angle defined by an axis of the drill bit and a tangent of the two knife-edges is in a range from about 15 degrees to about 35 degrees. The coating is formed on a surface of the drill bit. Thus, strength, lubricity, scraps discharge performance of the drilling pin have been greatly improved, and abrasion and thermal budget phenomena can be decreased. Therefore, the service life of the drilling pin can be greatly extended.

### BACKGROUND

The present invention relates to drilling pins, particularly, to a drilling pin for machining metal substrates.

Conventional printed circuit boards applied to various electronic devices are made of plastic or fiberglass materials. With the development of manufacture technology and the reduce of manufacture cost, those plastic or fiberglass materials of printed circuit boards are partially replaced by metal substrates which composed of those plastic or fiberglass materials combining with aluminum or copper. For example, printed circuit boards used in street lamps, car headlamps, and so on can be made of metal substrates. Printed circuit boards made of metal substrates not only have a high-density circuit, but also high intensity and rigidity. As a fundamental tool for fabricating of printed circuit boards, the conventional drilling pin has to be innovated to accommodate to the machining of the metal substrates.

A conventional drilling pin includes a drillstock and a drill bit extending from the drillstock. The drill bit includes two corresponding helix guide grooves. Each of the two helix guide grooves includes a knife-edge defined on one side thereof. A helix angle of the knife-edge is in a range from about 35 degrees to about 40 degrees.

However, the conventional drilling pin is suitable for machining the printed circuit boards made of plastic or fiberglass substrate. With respect to the printed circuit boards made of the metal substrate, the helix angle of the conventional drilling pin is relatively large, thus scraps produced during the machining process cannot be removed effectively, thereby a service life of the drilling pin can be greatly shorten. In addition, the conventional drilling pin has a relatively low surface rigidity and lubricity due to not any coating applied to the drill bit, during the drilling process, the drill bit may be fast abraded and produce thermal budget.

Therefore, a drilling pin accommodating to the machining of the printed circuit boars made of metal substrate and overcomes the above-mentioned problems is desired.

### BRIEF SUMMARY

An embodiment of a drilling pin for machining metal substrates is provided. Each of knife-edges of the drilling pin has a suitable helix angle, and has a coating applied to a surface of a drill bit of the drilling pin. Thus, strength, lubricity, scraps discharge performance of the drilling pin have been greatly improved, and abrasion and thermal budget phenomena can be decreased. Therefore, the service life of the drilling pin can be greatly extended.

A drilling pin for machining metal substrates includes a drillstock, a drill bit, and a coating. The drill bit extends from an end of the drillstock, and includes at least two corresponding helix guide grooves. Two knife-edges are formed/defined between the at least two helix guide grooves. A helix angle defined by an axis of the drill bit and a tangent of the two knife-edges is in a range from about 15 degrees to about 35 degrees. The coating is formed on a surface of the drill bit.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front view of a drilling pin, in accordance with a present embodiment.

FIG. 2 is a partial enlarged view of the drilling pin of FIG. 1.

FIG. 3 is a top view of the drilling pin of FIG. 2.

FIG. 4 is a sectional view of FIG. 3 along line 4-4.

### DETAILED DESCRIPTION

Embodiments will now be described in detail below and with reference to the drawings.

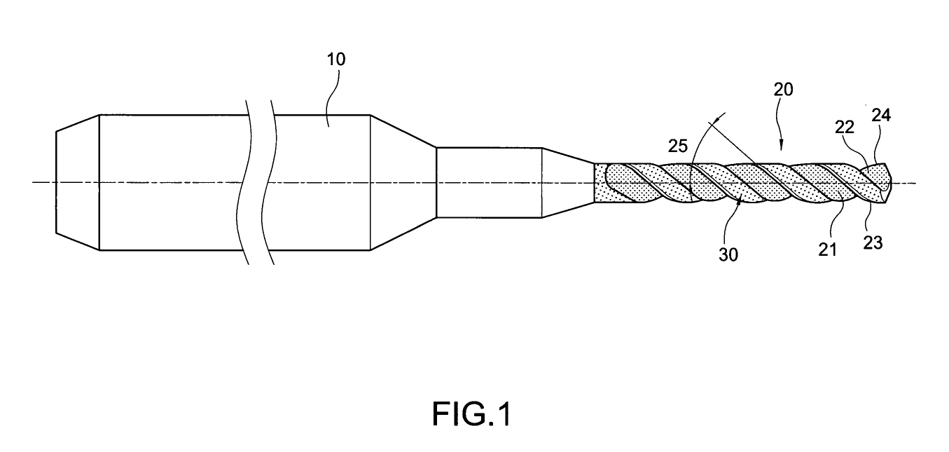

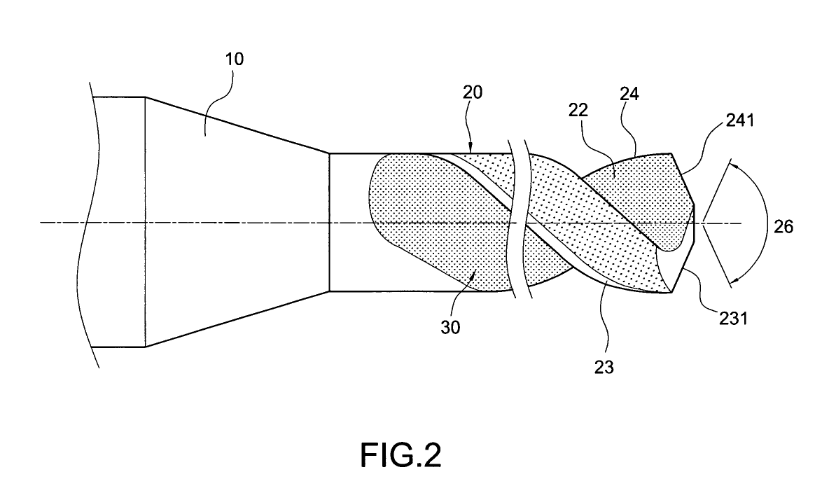

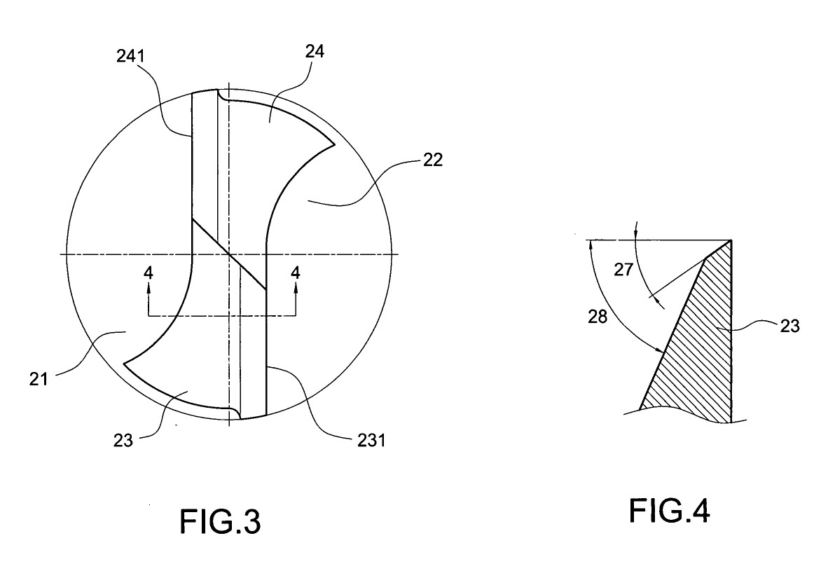

Referring to FIGS. 1 to 4, a drilling pin for machining metal substrates is provided. The drilling pin includes a drillstock 10, a drill bit 20, and a coating 30. The drillstock 10 can be a circular shaped straight role. The drill bit 20 extends from a bottom end of the drillstock 10. The drill bit 20 defines at least two helix guide grooves. In the present embodiment, the drill bit 20 includes a first helix guide groove 21 and a second helix guide groove 22 corresponding to the first helix guide groove 21. Certainly, the drill bit 20 is not limited to be three or more guide grooves configurations. A first knife-edge 23 is defined on a side of the first helix guide groove 21, and a second knife-edge 24 is defined on a side of the second helix guide groove 22. Thus, two knife-edges 23, 24 are formed between the two helix guide grooves 21, 22. An axis of the drill bit 20 and a tangent of each of the first and second knife-edges 23, 24 cooperatively define a helix angle 25. The helix angle 25 is in a range from about 15 degrees to about 35 degrees. Preferably, the helix angle 25 is about 32 degrees. On one hand, when the helix angle 25 is larger than 35 degrees, during the drilling process, the scraps cannot be discharged effectively, and a lot of scraps may be accumulated in the first and second helix guide grooves 21, 22, thereby causing a quick rise of a temperature of the first and second knife-edges 23, 24. In such circumstance, a quality of the printed circuit boards may be affected due to the quick rise of the temperature of the first and second knife-edges 23, 24. On the other hand, when the helix angle is less than 15 degrees, an intensity of the first and second knife-edges 23, 24 is decreased, thus the service life of the drilling pin can be shorten accordingly.

The first knife-edge 23 defines a first cut side 231, and the second knife-edge 24 defines a second cut side 241. Each of the first and second cut sides 231, 241 defines a point angle 26. The point angle 26 is in a range from about 90 degrees to about 130 degrees. Preferably, the point angle 26 is about 118 degrees. The first cut side 231 (or the second cut side 241) defines a first clearance angle 27 towards the first knife-edge 23, as shown in FIG. 4. The first clearance angle 27 is in a range from about 8 degrees to about 15 degrees. Preferably, the first clearance angle 27 is about 12 degrees. Furthermore, a second clearance angle 28 is defined behind the first clearance angle 27. The second clearance angle 28 is about 25 degrees to about 35 degrees. Preferably, the second clearance angle 28 is about 30 degrees.

The coating 30 is made of nano-materials, such as a nano-zirconium (Zr) material, a nano-chromium (Cr) material, a nano-titanium (Ti) material, an alloy of titanium and aluminum or other high rigidity materials. The coating 30 is formed on a surface of the drill bit 20 using a physical vapor deposition (PVD) method. The PVD method includes a sputtering method, a heat evaporation method, and so on. In the present embodiment, the coating 30 is deposited on the surface of the drill bit 20 by the sputtering method. In detail, the coating 30 is uniformly deposited on surfaces of the first and second knife-edges 23, 24, and certainly on the first and second cut sides 231, 241.

The drilling pin of the present embodiment has following advantage. The helix angle 25 is configured in about 15 degrees to about 35 degrees, the first and second knife-edges 23, 24 have high strength, excellent abrasion-proof, little resistance and excellent scraps discharge performance, thereby obtains a long service life. In addition, the drill bit 20 has high rigidity and excellent lubricity due to the presence of the coating 30, thus the abrasion of the first and second knife-edges 23, 24 and the thermal budget phenomena can be avoided.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A drilling pin for machining metal substrates, comprising:
a drillstock;
a drill bit extending from the drillstock, comprising at least two corresponding helix guide grooves, two knife-edges being defined between the at least two helix guide grooves, a helix angle defined by an axis of the drill bit and a tangent of the two knife-edges being in a range from about 15 degrees to about 35 degrees; and
a coating formed on a surface of the drill bit.

2. The drilling pin as claimed in claim 1, wherein the helix angle is about 32 degrees.

3. The drilling pin as claimed in claim 1, wherein a point of each of the two knife-edges defines a cut side, a point angle defined by two cut sides of the two knife-edges is in a range from about 90 degrees to about 130 degrees.

4. The drilling pin as claimed in claim 3, wherein the point angle is about 118 degrees.

5. The drilling pin as claimed in claim 1, wherein a point of each knife-edge defines a cut side, the cut side defines a first clearance angle towards the corresponding knife-edge, the first clearance angle is in a range from about 8 degrees to about 15 degrees.

6. The drilling pin as claimed in claim 5, wherein the first clearance angle is about 12 degrees.

7. The drilling pin as claimed in claim 5, wherein a second clearance angle is defined behind the first clearance angle, the second clearance angle is in a range from about 25 degrees to about 35 degrees.

8. The drilling pin as claimed in claim 7, wherein the second clearance angle is about 30 degrees.

9. The drilling pin as claimed in claim 1, wherein the coating is a nano-coating.

10. The drilling pin as claimed in claim 9, wherein the nano-coating is a nano-zirconium material.

11. The drilling pin as claimed in claim 9, wherein the nano-coating is a nano-chromium material.

12. The drilling pin as claimed in claim 9, wherein the nano-coating is a nano-titanium material.

13. The drilling pin as claimed in claim 9, wherein the nano-coating is an alloy of titanium and aluminum.
